(19) United States
(12) Patent Application Publication
(10) Pub. No.: US 2026/0289753 A1
(43) Pub. Date: Sep. 24, 2026

(54) INFORMATION PROCESSING APPARATUS, INFORMATION PROCESSING METHOD, AND COMPUTER-READABLE NON-TRANSITORY STORAGE MEDIUM

(71) Applicant: Sony Group Corporation, Tokyo (JP)

(72) Inventor: Daisuke IRIE, Tokyo (JP)

(73) Assignee: Sony Group Corporation, Tokyo (JP)

(21) Appl. No.: 19/490,958

(22) PCT Filed: Nov. 28, 2023
(86) PCT No.: PCT/JP2023/042454

§ 371 Date: Dec. 8, 2025

(30) Foreign Application Priority Data
Jun. 29, 2023 (JP) 2023-107373

(51) Int. Cl. G06T 5/77; G06T 5/60; G06T 7/246; G06T 7/50; G06V 10/25; G06V 10/26; G06V 20/40

(52) U.S. Cl. CPC G06T 5/77; G06T 5/60; G06T 7/248; G06T 7/50; G06V 10/25; G06V 10/26; G06V 20/41; G06T 2207/10016; G06T 2207/20084

(57) ABSTRACT

An information processing apparatus includes a motion compensation unit, an occlusion region detection unit, a ghost removal unit, and a DNN. The motion compensation unit performs motion compensation on an inference result for a past frame to generate corrected history. The occlusion region detection unit detects an occlusion region in the corrected history in which a ghost may occur based on a motion vector indicating a motion of a subject between frames. The ghost removal unit performs ghost removal processing on the occlusion region. The DNN infers a current frame, based on the corrected history subjected to the ghost removal processing and current which is an image of the current frame to be processed.

### TECHNICAL FIELD

The present invention relates to an information processing apparatus, an information processing method, and a computer-readable non-transitory storage medium.

### BACKGROUND ART

In Deep Neural Network (DNN) processing for moving images, a Recurrent Neural Network (RNN) structure, which has high time stability, is generally used. This is because the RNN structure can correlate current (current information) and history (past information), and thus easily maintain the consistency of the video of an output frame.

### CITATION LIST

### Patent Literature

PTL 1: JP2022-547517 T

### SUMMARY

### Technical Problem

The history is used as an input of the DNN together with the current. In order to maintain consistency with the current, the history is subjected to correction that takes into account the motion between frames; the correction is referred to as motion compensation. The motion compensation is performed as processing of predicting data of a current frame from a past frame, based on the motion between the frames. However, in a case where a background portion is exposed by movement of a foreground, the data of the background portion cannot be predicted from the history. Accordingly, data disturbance referred to as a ghost occurs in the history subjected to the motion compensation (corrected history). The ghost affects an inference result for the DNN and causes video quality to be degraded.

Thus, the present disclosure proposes an information processing apparatus, an information processing method, and a computer-readable non-transitory storage medium that are capable of suppressing disturbance of a video due to a ghost.

### Solution to Problem

According to the present disclosure, an information processing apparatus is provided that includes a motion compensation unit configured to generate corrected history by performing motion compensation on an inference result for a past frame, an occlusion region detection unit configured to detect an occlusion region in the corrected history in which a ghost has a possibility of occurring, based on a motion vector indicating a motion of a subject between frames, a ghost removal unit configured to perform ghost removal processing on the occlusion region, and a DNN configured to infer a current frame, based on the corrected history on which the ghost removal processing has been performed and current that is an image of the current frame to be processed, The present disclosure provides an information processing method in which a computer executes information processing of the information processing apparatus, and a computer-readable non-transitory storage medium storing a program that causes a computer to implement the information processing of the information processing apparatus,

### BRIEF DESCRIPTION OF DRAWINGS

FIG. 1 is a diagram illustrating existing DNN processing for moving images.

FIG. 2 is a diagram for describing occurrence of a ghost due to motion compensation.

FIG. 3 is a diagram for describing occurrence of a ghost due to motion compensation.

FIG. 4 is a diagram illustrating a configuration example of an information processing apparatus that performs DNN processing for moving images according to the present disclosure.

FIG. 5 is a diagram illustrating an example of ghost removal processing.

FIG. 6 is a diagram illustrating an example of the ghost removal processing.

FIG. 7 is an explanatory diagram of a learning method of a DNN.

FIG. 8 is an explanatory diagram of the learning method of the DNN.

FIG. 9 is a diagram illustrating an example of a method of detecting an occlusion region.

FIG. 10 is a diagram illustrating an example of the method of detecting an occlusion region.

FIG. 11 is a diagram illustrating another configuration example of performing the DNN processing for moving images according to the present disclosure.

FIG. 12 is a diagram illustrating an example of the ghost removal processing.

FIG. 13 is a diagram illustrating an example of a method of calculating an approximate feature amount.

FIG. 14 is a diagram for describing an intermediate feature amount.

FIG. 15 is an explanatory diagram of the learning method of the DNN.

FIG. 16 is a diagram illustrating an example of a processing flow for performing inference processing.

FIG. 17 is a diagram illustrating an example of the processing flow for performing the inference processing.

FIG. 18 is a diagram illustrating an example of a hardware configuration of an information processing apparatus.

### DESCRIPTION OF EMBODIMENTS

Hereinafter, embodiments of the present disclosure will be described in detail with reference to the drawings. In the following embodiments, the same components are denoted by the same reference numerals, and redundant description thereof will be omitted.

The description will be given in the following order.
1. Background
   1-1. Existing DNN Processing for Moving Images
   1-2. Occurrence of Ghost Due to Motion Compensation
2. Example 1 of DNN Processing for Moving Images According to Present Disclosure
   2-1. System Configuration Example
   2-2. Ghost Removal Processing
   2-3. Detection of Occlusion Region
   2-4. Effects
3. Example 2 of DNN Processing for Moving Images According to Present Disclosure
   3-1. System Configuration Example
   3-2. Ghost Removal Processing Using Approximate Feature Amount
   3-3. Processing Flow
   3-4. Effects
4. Hardware Configuration Example

### 1. Background

### 1-1. Existing DNN Processing for Moving Images

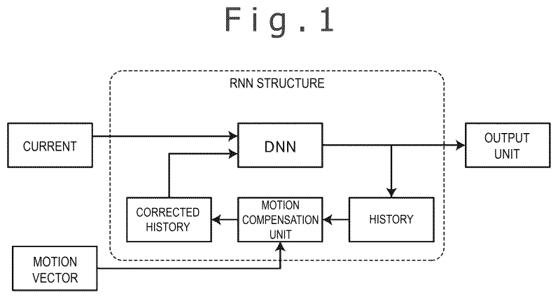

FIG. 1 is a diagram illustrating existing DNN processing for moving images.

In DNN processing for moving images, an RNN structure, which has high time stability, is generally used. The RNN structure can correlate current and history, and thus easily maintain the consistency of the video of an output frame. The DNN has very high inference performance (for example, a sharpening effect in the case of super-resolution), but is affected by a small change in input data, leading to a change in output result. Accordingly, in moving image processing, flicker is more likely to occur than in simple filter processing. In order to improve time stability and suppress flicker, an RNN structure is generally implemented to which current and history are simultaneously input and which can perform learning including learning of time correlation (similarity between the current and the history).

Note that the current means an image of a frame to be estimated by the DNN (current frame). The history means an image obtained by inputting an image of a past frame to the DNN (estimated image), or an intermediate feature amount extracted from the image of the past frame. The past frame means a frame one or more frames before the current frame. In the present disclosure, for example, a frame one frame before the current frame (the most recent frame) is used as the past frame.

The intermediate feature amount means information of a feature amount output from an intermediate layer of the DNN when the image of the past frame is input to the DNN. Using the intermediate feature amount in the past frame as the history is known to produce an estimation result with higher accuracy than using the image of the past frame as the history.

The history is used as an input of the DNN together with the current. In order to maintain consistency with the current, motion compensation based on a motion vector is performed on the history. The motion vector means a vector indicating a motion of a subject between frames (an amount and a direction of movement of pixels). The motion compensation means processing of predicting data after motion from data before motion. For example, in a case where the motion compensation is applied to the shape or feature of the image of the past frame, the shape or feature of the image predicted in the current frame is acquired as corrected history. The history subjected to the motion compensation (corrected history) is input to the DNN together with the current.

### 1-2. Occurrence of Ghost Due to Motion Compensation

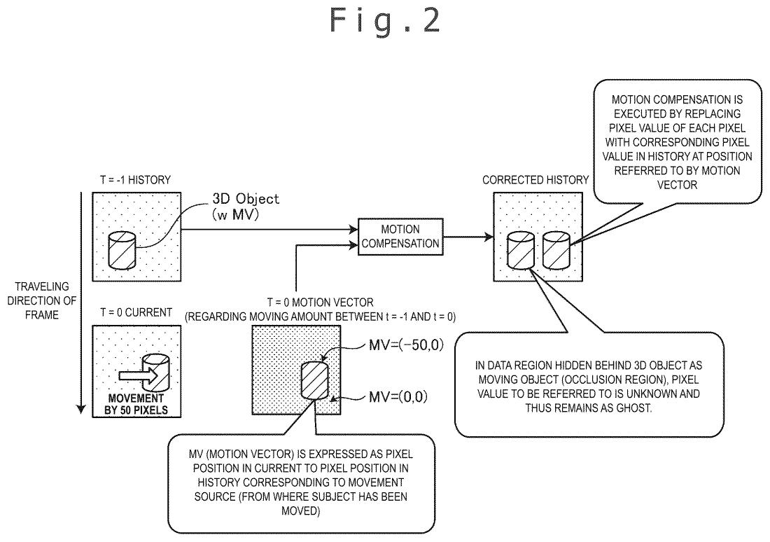

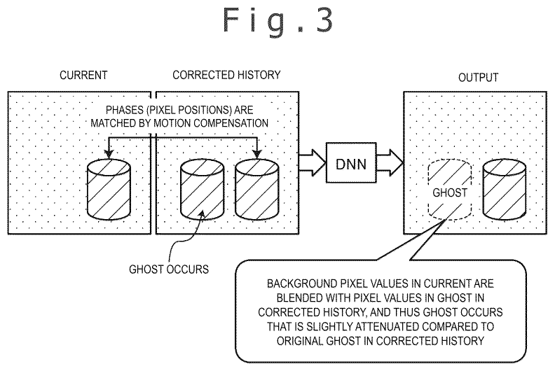

FIGS. 2 and 3 are diagrams for describing occurrence of a ghost due to the motion compensation.

FIG. 2 illustrates an example in which a 3D object that is a moving object moves rightward by 50 pixels with progression of the frame. “t” indicates a frame number. The current is the image of the current frame (t=0). The history is an inferred image of the past frame (t=−1). A motion vector MV is a two dimensional vector indicating the motion of the subject. The motion vector MV is defined for each pixel of the current.

For example, the horizontal direction is assumed to be an x direction, and the vertical direction is assumed to be a y direction. The 3D object has moved from the left side (−x direction), and thus the motion vector MV of the drawing position of the 3D object is (−50, 0). A still portion is not in motion, and thus the motion vector MV is (0, 0). The motion vector MV is expressed as a vector from the current pixel position to the pixel position of the history as a movement source (from where the subject has moved).

The corrected history is acquired by performing the motion compensation on the history. The motion compensation is performed in the manner of applying pixel values in the history to pixels in a movement destination determined from the motion vector.

For example, an image region in which a 3D object is presented is referred to as a moving object region. The motion vector MV of the moving object region is (−50, 0). Accordingly, in the current frame (t=0), the moving object region has been moved to a position that is 50 pixels away toward the right as compared with the past frame (t=−1), Thus, the pixel values in the moving object region in the history are applied to an image region obtained by displacing the moving object region rightward by 50 pixels. For the image region other than the moving object region, the motion vector MV is (0, 0). Accordingly, no change has occurred in the image between the current frame and the past frame. Thus, the pixel values are not replaced.

When the 3D object as a moving object moves, a portion (occlusion region) hidden behind the moving object is exposed. The occlusion region cannot be predicted from the history because the occlusion region is not exposed until the current is reached. Even when an attempt is made to perform the motion compensation on the occlusion region, the pixel value to be referred to based on the motion vector is unknown. Accordingly, in the history subjected to the movement compensation (corrected history), a data disturbance (ghost) indicating a trace of the 3D object occurs. In the DNN, processing like blending of the current and the corrected history is performed. When the corrected history including the ghost is input to the DNN, a video is generated in which the 3D object before the movement is reflected as a shadow. This degrades video quality.

The present disclosure has been made in view of such circumstances. In the present disclosure, in the corrected history, an occlusion region where a ghost may occur is detected based on the motion vector MV. Then, ghost removal processing is performed on the occlusion region. DNN inference is performed based on the corrected history on which the ghost removal processing has been performed, and thus the disturbance of the video due to the ghost is suppressed.

In the existing method, a disturbed portion (noise region) of the video is detected from an inferred video, and the DNN is optimized by a loss function that adds load to the noise region. However, in this method, the non-noise region is relatively less optimized, and the inference accuracy is lowered. Additionally, it is difficult to detect a noise region from an inferred image even by using a dedicated identification model. For example, it is difficult to distinguish a blur caused by replacement of pixel values during the motion compensation, a flicker as video expression, or the like (non-ghost region) from video distortion caused by a ghost.

In the approach of the present disclosure, in the corrected history, a data region (occlusion region) where a ghost may occur is accurately located based on the motion vector. The ghost is removed by directly correcting the data of the occlusion region, and thus the accuracy of estimation of a non-ghost region such as a blur or a flicker is unlikely to decrease. Thus, the disturbance of the video image caused by the ghost is suppressed more favorably than in the existing method.

This will be described in detail below.

### 2. Example 1 of DNN Processing for Moving Images According to Present Disclosure

### 2-1. System Configuration Example

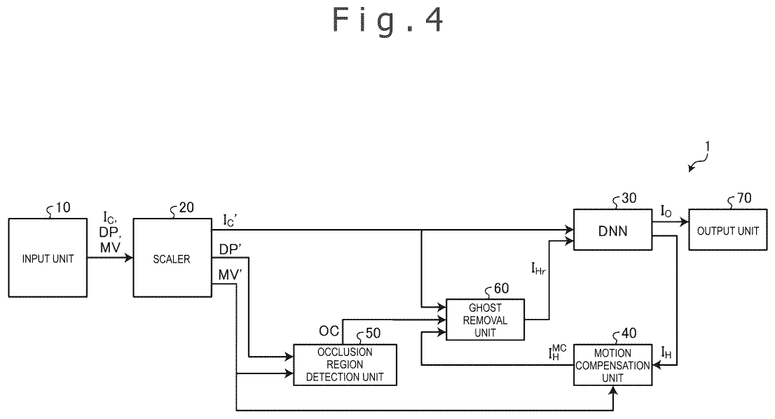

FIG. 4 is a diagram illustrating a configuration example of the information processing apparatus 1 that performs the DNN processing for moving images according to the present disclosure. In the example of FIG. 4, an inferred image of a past frame inferred by the DNN is used as history I_{H}.

The DNN processing for moving images according to the present disclosure is performed by the information processing apparatus 1. For example, the information processing apparatus 1 includes an input unit 10, a scaler 20, a DNN 30, a motion compensation unit 40, an occlusion region detection unit 50, a ghost removal unit 60, and an output unit 70.

The input unit 10 acquires current Ic, a depth image DP, and the motion vector MV. The current I_{C} indicates an image of one frame among consecutive frames such as moving images. The current I_{C} may be an image captured by a camera or a CG image generated by a CG renderer. The block diagram of FIG. 4 illustrates operation on one frame of a moving image.

The depth image DP is a one dimensional image representing a depth. The depth image DP can be acquired by estimation using a group of consecutive frames or estimation using a depth estimation DNN. In a case where the CG renderer is used, the depth image DP can be generated and acquired at the time of rendering,

The motion vector MV is a two dimensional vector that defines the movement of corresponding pixels between frames according to the amount of movement of pixels (the number of pixels) in the x direction and the y direction. The motion vector MV can be acquired by general estimation processing using a group of consecutive frames. In a case where the CG renderer is used, the motion vector MV can be generated and acquired during rendering.

The scaler 20 expands the number of pixels of the current I_{C}, the depth image DP, and the motion vector MV as necessary. Hereinafter, in a case where data subjected to expansion of the number of pixels by the scaler 20 needs to be distinguished from data before the expansion, ″′″ is added after the reference numeral of the data. The scaler 20 sends current I_{C}′ to the DNN 30 and the ghost removal unit 60. The scaler 20 sends a depth image DP′ to the occlusion region detection unit 50. The scaler 20 sends a motion vector MV′ to the occlusion region detection unit 50 and the motion compensation unit 40.

In a case where the number of the pixels accepted by the architecture of the DNN 30 is fixed, whereas the number of the pixels of the current I_{C} varies depending on the usage, the scaler 20 may perform the processing of expanding the number of the pixels at a desired scale factor so as to obtain the number of pixels according to the specifications of the DNN 30. The method of expanding the current I_{C} may be freely selected, for example, bilinear or bicubic. For the method of expanding the depth image DP and the motion vector MV, the nearest neighbor method is desirably applied in order to avoid generation of an intermediate value due to pixel interpolation, but the method is not limited thereto.

The DNN 30 receives, as input, the current I_{C}′ and corrected history I_{H}^{MC} subjected to the ghost removal (the rectified history I_{Hr}), and outputs an output image I_{O}. The DNN 30 sends the output image I_{O} to the output unit 70. A value learned in advance is used as a coefficient value of the DNN 30. A learning task of the DNN 30 is assumed to be, for example, super-resolution, noise reduction, or style transfer, but the present disclosure is not limited thereto. The DNN 30 can be applied to general moving image processing using an RNN structure.

The motion compensation unit 40 acquires, from the DNN 30, the history IH, which is an inference result for a past frame. In the example of FIG. 4, the history IH is an inferred image of the past frame inferred by the DNN 30. The motion compensation unit 40 performs the motion compensation on the history IH, based on the motion vector MV′ to generate corrected history I_{H}^{MC} The motion Compensation unit 40 can apply, to the history IH, general processing known as the motion compensation.

The motion vector MV′ has a vector related to a spatial movement amount from the history I_{H} to the current I_{C}. The motion compensation causes the positions of the pixels of the history I_{H} to coincide with the positions of the corresponding pixels of the current I_{C}. The motion compensation unit 40 sends the history I_{H} subjected to the motion compensation (corrected history I_{H}^{MC}) to the ghost removal unit 60.

The occlusion region detection unit 50 detects a data region in the corrected history I_{H}^{MC} where a ghost may occur, as an occlusion region, based on the depth image DP′ and the motion vector MV′. Any method may be used to detect the occlusion region. For example, the occlusion region may be located based on the depth information of the current frame and the past frame.

The occlusion region detection unit 50 generates an occlusion map OC in which the occlusion region is labeled, and sends the occlusion map OC to the ghost removal unit 60. For example, the occlusion map OC labels the occlusion region and a region (non-occlusion region) other than the occlusion region according to occlusion values. For example, “0” is set as an occlusion value for each pixel included in the occlusion region, and “1” is set as an occlusion value for each pixel included in the non-occlusion region.

The ghost removal unit 60 performs ghost removal processing on the occlusion region. The ghost removal unit 60 sends, to the DNN 30, the corrected history I_{H}^{MC} subjected to the ghost removal processing (the rectified history I_{Hr}). The DNN 30 infers the current frame, based on the rectified history I_{Hr} and the current I_{C}′, which is the image of the current frame to be processed. The DNN 30 sends the output image I_{O}, which is an inference result, to the output unit 70. The output unit 70 applies general post-processing such as color conversion and codec to the output image I_{O} acquired from the DNN 30.

For example, the ghost removal unit 60 can perform, as the ghost removal processing, processing of replacing the pixel value of each pixel in the occlusion region with blank data. The ghost removal unit 60 can also perform, as the ghost removal processing, processing of replacing the pixel value of each pixel in the occlusion region with the corresponding pixel value in the current I_{C}′.

The blank data means data indicating a specific value set in the system. The blank data can be freely set by a system developer. For example, the blank data is set as data indicating 0, but data indicating an intermediate gradation may be set as the blank data. The intermediate gradation means a gradation between the lowest gradation and the highest gradation that can be displayed.

The DNN 30 calculates the pixel value of each pixel in the occlusion region as a value obtained by blending the corresponding pixel value in the current I_{C}′ and blank data. Accordingly, in a case where 0 indicating the lowest gradation is used as the blank data, luminance may become insufficient when a high-luminance image is input as the current I_{C}′ In the method of using, as the blank data, the data indicating the intermediate gradation or using the pixel values in the current I_{C}′, the luminance is unlikely to become insufficient.

### 2-2. Ghost Removal Processing

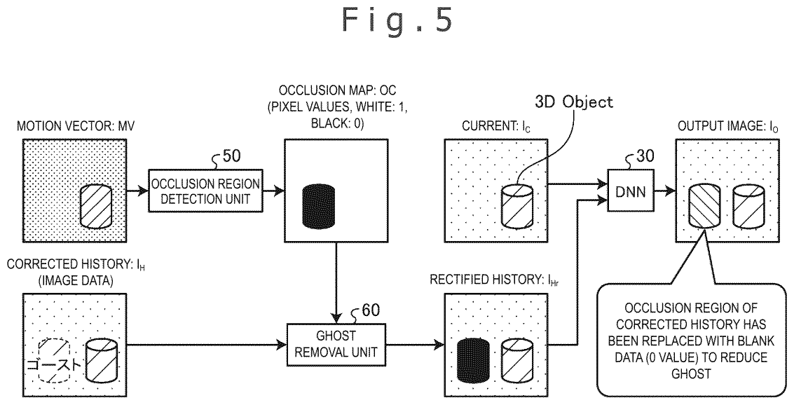

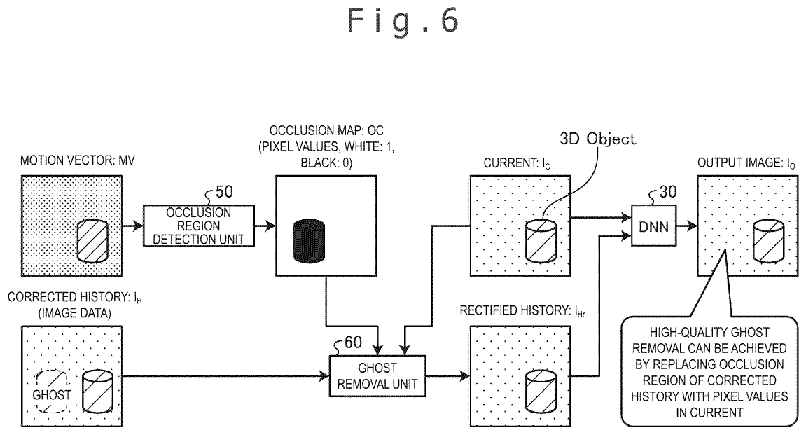

FIGS. 5 and 6 are diagrams illustrating an example of the ghost removal processing.

In the example of FIG. 5, the data indicating “0” as the blank data is used. In the DNN 30 of the RNN structure, a ghost may occur due to motion compensation. Thus, the processing of removing the ghost is performed by using the blank data to directly correct the occlusion region located from the motion vector MV′ or the like.

In the example of FIG. 5, the occlusion region is the image region of a portion of the past frame where the 3D object is present. Each of the pixel values in the occlusion region of the rectified history I_{Hr} has been replaced with 0 (black), which is the lowest gradation. Accordingly, the ghost of the output image I_{O} has been reduced, However, the DNN 30 blends the background color of the current I_{C}′ and the black color of the blank data, and thus a background color with a slightly reduced luminance may be generated and remain as an artifact.

In the example of FIG. 6, the pixel values in the occlusion region of the rectified history I_{Hr} have been replaced with the corresponding pixel values in the current I_{C}′. The background color of the rectified history I_{Hr} blended with the current I_{C}′ is the background color of the same current. Accordingly, the luminance of the background color is less likely to decrease than in a case where the correction is performed using the blank data as in the example of FIG. 5. Thus, ghost removal with high quality can be performed.

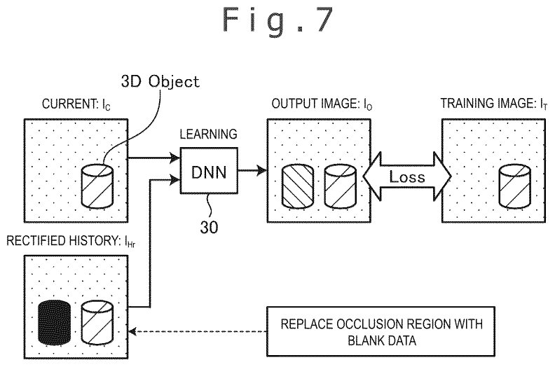

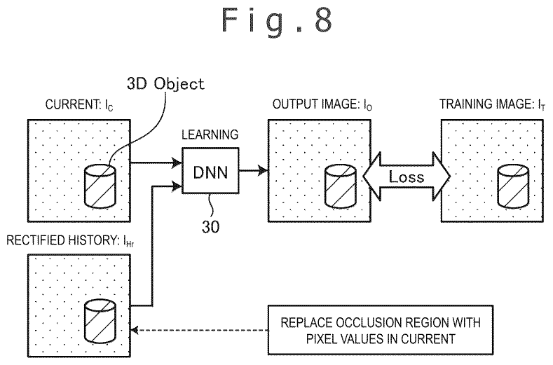

FIGS. 7 and 8 are explanatory diagrams of a learning method of DNN 30.

The learning method of the DNN 30 varies depending on how to handle the occlusion region during an actual operation. For example, the example of FIG. 7 is a learning example in a case where the example of FIG. 5 is assumed as an actual operation. During learning, the rectified history I_{Hr} in which the occlusion region has been replaced with the blank data is used as an input to the DNN 30, as in the actual operation.

The rectified history I_{Hr} and the current I_{C} are input to the DNN 30, and the output image I_{O} is acquired. The DNN 30 is optimized to reduce the difference between the output image I_{O} and a training image I_{T}, using the loss function. The training image I_{T} is determined according to the application of the DNN 30. For example, in a case of aiming at super-resolution, an image having a higher resolution than the current I_{C} is used as the training image I_{T}.

Using the rectified history I_{Hr} as an input to the DNN 30 enables an increase in the inference accuracy of the DNN 30 during the actual operation. When the corrected history I_{H}^{MC} is input to the DNN 30 instead of the rectified history I_{Hr}, the coefficient of the DNN 30 is optimized by the data including the ghost. In this case, the inference accuracy may decrease with respect to the data including no ghost (rectified history I_{Hr}). As described above, by matching the types of data for input during learning and during actual operation, appropriate learning and inference are performed.

The example of FIG. 8 is a learning example in a case where the example of FIG. 6 is assumed as the actual operation. In this example, during learning, the rectified history I_{Hr} in which the occlusion region has been replaced with the corresponding pixel values in the current I_{C} is used as an input to the DNN 30, as in the actual operation. The rectified history I_{Hr} and the current I_{C} are input to the DNN 30, and the output image I_{O} is acquired. The DNN 30 is optimized to reduce the difference between the output image I_{O} and a training image I_{T} using the loss function. This increases the inference accuracy of the DNN 30 during the actual operation.

### 2-3. Detection of Occlusion Region

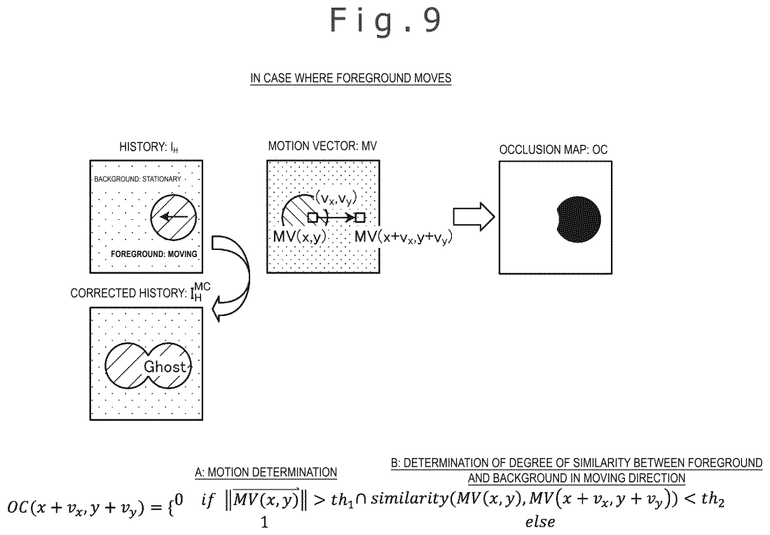

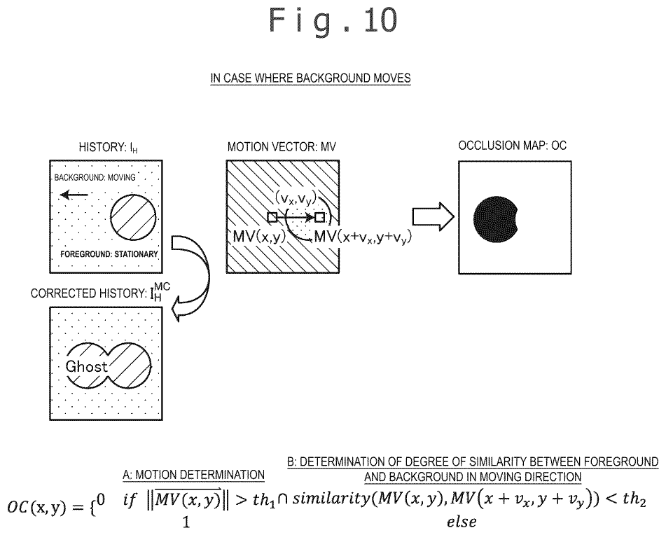

FIGS. 9 and 10 are diagrams illustrating an example of a method of detecting an occlusion region.

The occlusion region detection unit 50 detects, based on the motion vector MV, the motion of a moving object as a foreground and the motion of a background (an image region as a reference destination from the foreground via the motion vector) hidden behind the moving object, The occlusion region detection unit 50 detects an occlusion region, based on the movement of the foreground and the background.

For example, the occlusion region detection unit 50 calculates the magnitude of misalignment and the degree of similarity in the moving direction between the foreground and the background, based on the motion vector MV. In a case where the magnitude of the misalignment is not at a noise level (condition A) and the degree of similarity in the moving direction does not satisfy a similarity condition (condition B), the occlusion region detection unit 50 determines that the region of the background overlapping the foreground is an occlusion region. In the present disclosure, “the degree of similarity between the moving direction of the foreground and the moving direction of the background does not satisfy the similarity condition” may be simply expressed as “the moving direction of the foreground is different from the moving direction of the background”.

The degree of similarity can be calculated using the distances of vectors, cosine similarity, or the like. The noise level means that the magnitude of misalignment is large enough to be regarded as noise. That is, the condition A may be regarded as a condition that the magnitude of misalignment between the foreground and the background is larger than a threshold value representing noise. The similarity condition means a condition for determining similarity. The noise level and the similarity condition are hyperparameters that affect the inference accuracy of the DNN 30. These hyperparameters can be freely set by a system developer using a threshold value or the like while checking for a ghost actually caused by the motion compensation.

That is, the occlusion region detection unit 50 determines, based on the motion vector MV, whether the predetermined conditions are satisfied, the predetermined conditions including the condition that the magnitude of misalignment between the foreground and the background is larger than the threshold value indicating noise (condition A) and the condition that the moving direction of the foreground is different from the moving direction of the background (condition B), The occlusion region detection unit 50 determines that the region of the background overlapping the foreground is an occlusion region, if it is determined that the predetermined conditions are satisfied.

The example of FIG. 9 illustrates a case where the foreground moves In a case where the reference destination of the foreground is smaller in motion amount than the foreground, occlusion is considered to be occurring, In FIG. 9, the background is stationary and the foreground is moving to the left. The motion vector MV of a foreground pixel (x, y) is (Vₓ, V_{y}). The occlusion region in a case where the foreground moves is a region that satisfies both the motion determination regarding the condition A (whether the moving object corresponding to the foreground has moved from the original location) and the degree of similarity determination regarding the condition B (whether the original location has not moved in the same direction as the moving object). The condition B suggests that occlusion does not occur in a case where the background moves at a speed similar to that of the foreground,

For example, for a certain pixel (x, y), whether an occlusion value OC (x+vₓ, y+v_{y}) is “0” (the pixel is included in the occlusion region) or “1” (the pixel is not included in the occlusion region) can be determined based on the equation illustrated in FIG. 9. In the equation, “similarity” is a function indicating the degree of similarity between two motion vectors MV. “th₁” is a threshold value indicating the noise level. “th₂” is a threshold value indicating the degree of similarity condition. “MV (x+vₓ, y+v_{y})” is the motion vector of the pixel (x+vₓ, y+v_{y}) in the background which is the reference destination of the pixel (x, y) in the foreground.

The example of FIG. 10 illustrates a case where the background moves. As in the example of FIG. 9, the occlusion region in the case where the background moves is detected as a region that satisfies both the motion determination regarding the condition A and the degree of similarity determination regarding the condition B. However, as indicated in the equation in FIG. 10, unlike in the case where the foreground moves, the coordinates of the determination result “OC (x, y)” are (x, y).

Although the case where the foreground moves (FIG. 9) and the case where the background moves (FIG. 10) are separately described here, the foreground and the background can be distinguished from each other based on the respective depths. For example, the occlusion region detection unit 50 identifies the foreground and the background, based on the depth information obtained from the depth image DP.

### 2-4. Effects

The information processing apparatus 1 includes the motion compensation unit 40, the occlusion region detection unit 50, the ghost removal unit 60, and the DNN 30. The motion compensation unit 40 performs the motion compensation on the inference result for the past frame to generate corrected history I_{H}^{MC} The occlusion region detection unit 50 detects an occlusion region in the corrected history I_{H}^{MC} where a ghost may occur, based on the motion vector MV indicating the motion of the subject between the frames. The ghost removal unit 60 performs the ghost removal processing on the occlusion region. The DNN 30 infers the current frame, based on the corrected history IHMC subjected to the ghost removal processing (rectified history I_{Hr}) and the current I_{C}′, which is the image of the current frame to be processed. In the information processing method of the present disclosure, the processing of the information processing apparatus 1 is executed by a computer. A computer-readable non-transitory storage medium according to the present disclosure stores a program that causes a computer to realize the processing of the information processing apparatus 1.

According to this configuration, the occlusion region in the corrected history I_{H}^{MC} is located based on the motion vector MV. Since the DNN 30 performs the inference based on the corrected history I_{H}^{MC} in which the ghost removal processing has been performed on the occlusion region (rectified history I_{Hr}) , the disturbance of the video due to the ghost is suppressed more effectively.

The motion compensation unit 40 generates corrected history I_{H}^{MC} by performing the motion compensation on the inferred image of the past frame inferred by the DNN 30.

According to this configuration, the corrected history I_{H}^{MC} is generated by a simple calculation, Additionally, since the corrected history I_{H}^{MC} is image data approximate to the current I_{C}′, the accuracy of estimation of the current I_{C}′ by the DNN 30 is improved.

The ghost removal unit 60 performs, as the ghost removal processing, processing of replacing the pixel value of each pixel in the occlusion region with blank data.

According to this configuration, ghosts are suppressed by a simple calculation.

The ghost removal unit 60 performs, as the ghost removal processing, processing of replacing the pixel value of each pixel in the occlusion region with the corresponding pixel value in the current I_{C}′.

According to this configuration, ghosts are removed well.

The occlusion region detection unit 50 determines, based on the motion vector MV, whether the predetermined conditions are satisfied, the predetermined conditions including the condition that the magnitude of misalignment between the foreground and the background is larger than the threshold value indicating noise and the condition that the moving direction of the foreground is different from the moving direction of the background. The occlusion region detection unit 50 determines that the region of the background overlapping the foreground is an occlusion region, if it is determined that the predetermined conditions are satisfied.

According to this configuration, the occlusion region can be adequately acquired.

The occlusion region detection unit 50 identifies the foreground and the background, based on the depth information.

According to this configuration, the foreground and the background can be adequately identified.

Note that the effects described herein are merely examples and are not limited, and other effects may be produced.

### 3. Example 2 of DNN Processing for Moving Images According to Present Disclosure

### 3-1. System Configuration Example

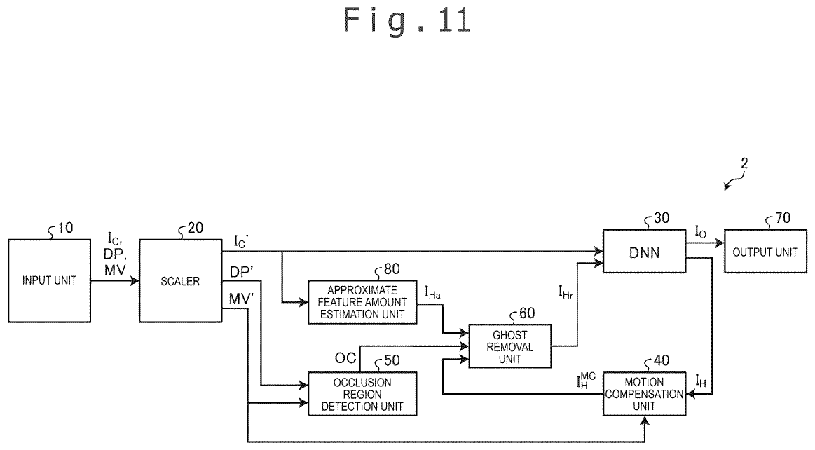

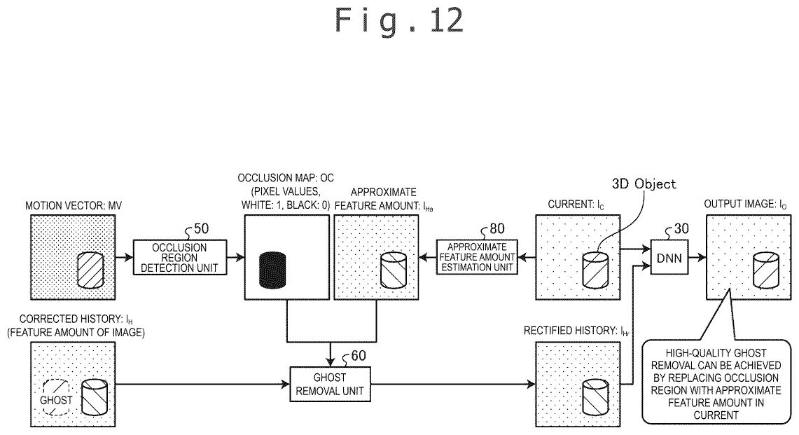

FIG. 11 is a diagram illustrating a configuration example of another information processing apparatus 2 that performs the DNN processing for moving images according to the present disclosure. FIG. 12 is a diagram illustrating an example of the ghost removal processing.

The present example is different from the information processing apparatus 1 of FIG. 4 in that the intermediate feature amount in the past frame inferred by the DNN is used as the history I_{H}, and the data of the occlusion region of the corrected history I_{H}^{MC} is replaced with a feature amount (approximate feature amount I_{Ha}) approximate to the intermediate feature amount in the current. Hereinafter, the differences from the information processing apparatus 1 will be mainly described.

The information processing apparatus 2 includes an approximate feature amount estimation unit 80. The motion compensation unit 40 generates corrected history I_{H}^{MC} by performing the motion compensation on the intermediate feature amount in the past frame inferred by the DNN 30 (history I_{H}). The approximate feature amount estimation unit 80 acquires a feature amount corresponding to the corrected history I_{H}^{MC}, from the current I_{C}′ as an approximate feature amount I_{Ha}. The ghost removal unit 60 performs, as the ghost removal processing, processing of replacing the data of the occlusion region in the corrected history I_{H}^{MC} with the data of the approximate feature amount I_{Ha}.

Note that the motion compensation unit 40 can also handle the inferred image of the past frame as the history I_{H} depending on the situation. For example, for a dark and monotonous video scene there is no problem even in a case where the inference quality is somewhat low. In this case, the occlusion region can be replaced with blank data as illustrated in FIG. 5 without handling the approximate feature amount requiring a large amount of calculation. The processing of using the inferred image of the past frame as the history I_{H} is the same as that described in the example of FIG. 4.

### 3-2. Ghost Removal Processing Using Approximate Feature Amount

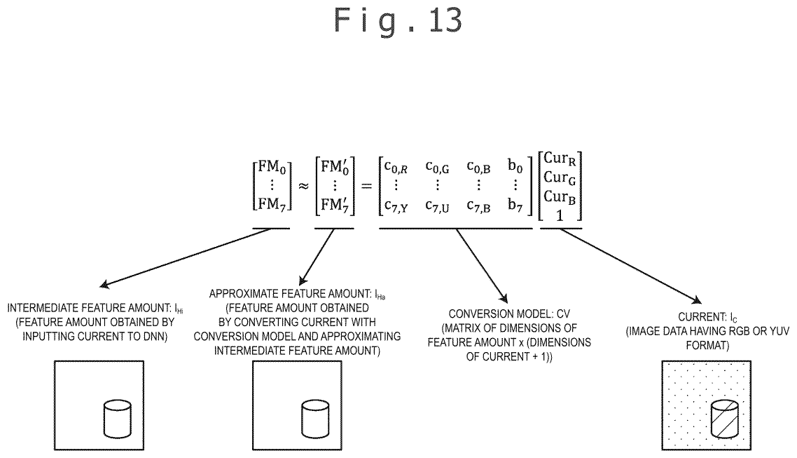

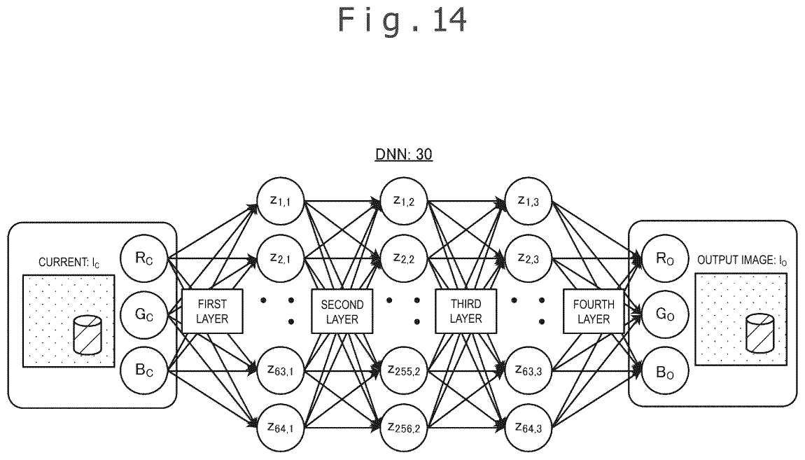

FIG. 13 is a diagram illustrating an example of a method of calculating the approximate feature amount I_{Ha}. FIG. 14 is a diagram illustrating an intermediate feature amount.

The intermediate feature amount indicates an internal feature amount of the DNN 30. FIG. 14 illustrates a state in which the current I_{C} is input to the DNN 30, and the feature amount Zₙ, 1 is obtained by convolution processing of a Convolutional Neural Network (CNN) layer. Here, “n” represents the number of dimensions. “l” represents a layer number. The DNN 30 is represented by four layers.

The final output of the DNN 30 is a three-dimensional RGB image obtained by compressing the 64-dimensional feature amounts of z_{1, 3} to z_{64, 3}. In the example of FIG. 14, the number of dimensions is 64, but the number of dimensions is determined depending on the configuration of the DNN 30 and need not be 64.

In the RNN structure, the inference accuracy is higher when such a higher multidimensional feature amount is used than when an RGB image is recursively used as an input. In the RNN structure of the present disclosure, the intermediate feature amount recursively used as the history I_{H} is a multidimensional feature amount (z_{1, 1} to Z_{n, 1}) in a certain specific layer. In practice, a feature amount immediately before the last layer (the output of the third layer in the example of FIG. 14) is desirably used, which is a feature amount closer to the output, that is, a feature amount that expresses the training data well.

The approximate feature amount estimation unit 80 applies conversion processing to the pixel values in the current I_{C} to approximate the feature amount in the history I_{H}. For example, the approximate feature amount estimation unit 80 optimizes a conversion model CV in such a manner that the intermediate feature amount obtained by applying the conversion model CV to the current I_{C} approximates the intermediate feature amount I_{H1} obtained by inputting the current I_{C} to the DNN 30. The approximate feature amount estimation unit 80 calculates, as the approximate feature amount I_{Ha}, the intermediate feature amount obtained by applying the current I_{C} to the optimized conversion model CV.

Optimization of the conversion model can be performed by a general regression model. FIG. 13 illustrates an example of multiple regression analysis. For example, the feature amount FM₀ of the 0-th dimension is obtained by determining coefficients c_{0, y} and b₀ by the multiple regression analysis to satisfy FM₀=c₀, _{Y}Cur_{R}+c₀, _{Y}Cur_{G} +c₀, _{Y}Cur_{B}+b₀. “Cur_{R}”, “Cur_{R}”, and “_{Y}Cur_{R}” indicate pixel values of R (red), G (green), and B (blue) in the current I_{C}. “c” and “b” represent coefficients of the conversion model CV.

In the example of FIG. 13, the feature amount has a total of eight channels (eight dimensions) from the 0th to the 7th, and the current I_{C} has a total of three channels of R, G, and B. Note that the number of dimensions of the feature amount and the channels of the current I_{C} are not limited to those described above. The number of dimensions of the feature amount may be nine or more, and the current I_{C} may be a YUV image.

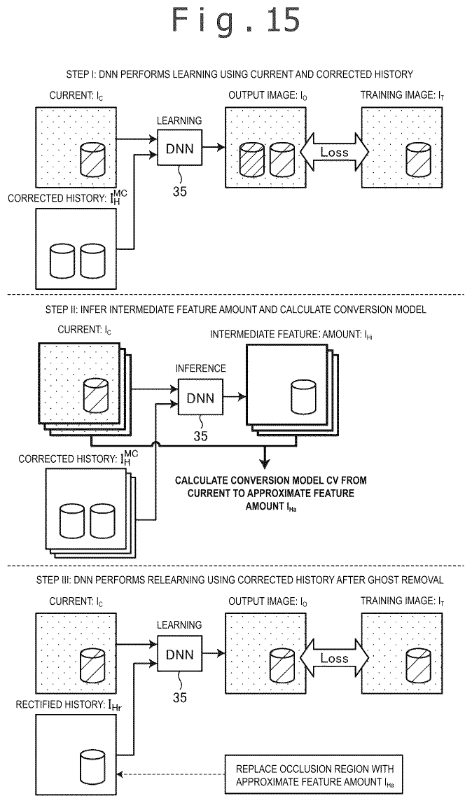

FIG. 15 is an explanatory diagram of a learning method of the DNN 30.

First, a DNN 35 performs learning using the corrected history I_{H}^{MC} on which the ghost removal processing has not been performed (step I), This learning uses the corrected history I_{H}^{MC} including a ghost, and is similar to the existing learning. The corrected history I_{H}^{MC} and the current Ic are input to the DNN 35, and the output image I_{O} is acquired. The DNN 35 is optimized so as to reduce the difference between the output image I_{O} and the training image I_{T} using the loss function.

Then, one or more currents I_{C} are inferred using the DNN 35 trained in step I. This processing causes the intermediate feature amount I_{Hi} to be acquired for each current I_{C}. The current I_{C} is associated with an intermediate feature amount I_{Hi} inferred from the current I_{C} to generate one pair data. For each pair data, a conversion model CV from the current I_{C} to the approximate feature amount T_{Ha}, which approximates the intermediate feature amount I_{Hi}, is calculated. One or more calculated conversion models CV are statistically processed to generate one conversion model CV (integrated model) (step II).

Then, the approximate feature amount I_{Ha} is acquired from the current I_{C} using the integrated model. The occlusion region of the corrected history I_{H}^{MC} is corrected by the approximate feature amount That to generate the rectified history I_{Hr}. The final DNN 30 is obtained by the DNN 35 performing relearning using the rectified history I_{Hr} (step III).

### 3-3. Processing Flow

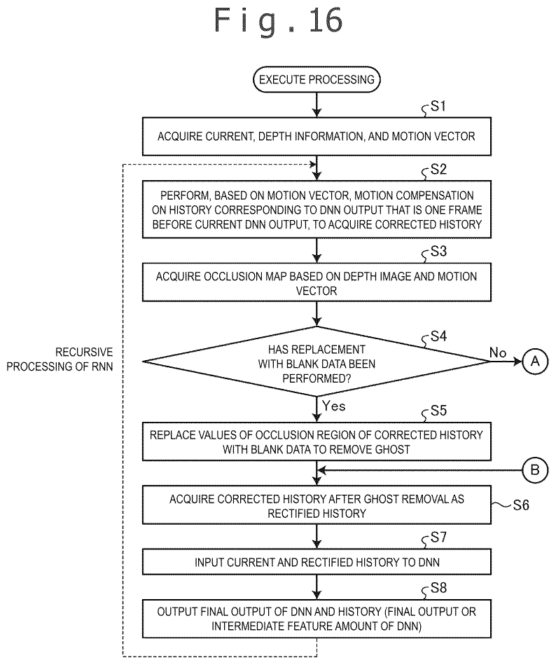

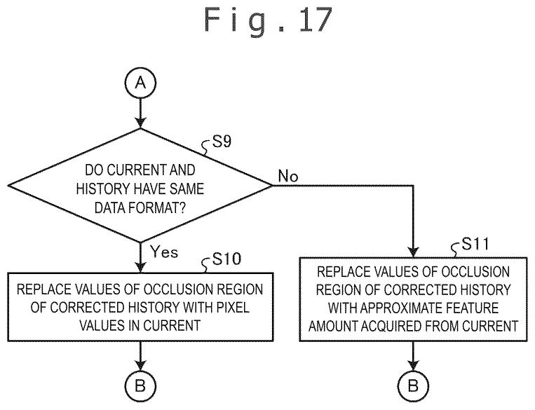

FIGS. 16 and 17 are diagrams illustrating an example of a processing flow for performing inference processing,

The input unit 10 acquires the current Ic, the depth image DP, and the motion vector MV. The scaler 20 expands the numbers of pixels in the current I_{C}, the depth image DP, and the motion vector MV as necessary to obtain current I_{C}′, a depth image DP′, and a motion vector MV′ (step S1).

The motion compensation unit 40 performs, based on the motion vector MV′, the motion compensation on the history I_{H}, which is a DNN output one frame before the current DNN output, and acquires the corrected history I_{H}^{MC} (step S2). The occlusion region detection unit 50 acquires the occlusion map OC, based on the depth image DP′ and the motion vector MV′ (step S3).

The ghost removal unit 60 determines whether to replace the occlusion region with blank data (step S4). What kind of data is used as the history and what kind of data is to be used to replace the occlusion region are determined depending on the video scene or the like. For example, for a dark and monotonous video scene, there is no problem even in a case where the inference quality is somewhat low. In this case, the processing of replacing the occlusion region with blank data is performed without handling the approximate feature amount requiring a large amount of calculation.

When the replacement with the blank data is performed (Step S4: Yes), the ghost removal unit 60 replaces the value of the occlusion region of the corrected history I_{H}^{MC} with the blank data, and removes the ghost (Step S5). The ghost removal unit 60 acquires the corrected history I_{H}^{MC} subjected to the ghost removal as the rectified history I_{Hr} (step S6).

The scaler 20 and the ghost removal unit 60 input the current I_{C}′ and the rectified history I_{Hr} to the DNN 30 (step S7), The DNN 30 outputs the output image I_{O}, corresponding to the final output, and the history I_{H} for the next video processing (output image I_{O} or intermediate feature amount) (step S8). Subsequently, the recursive processing of the RNN is repeated.

In a case where replacement with blank data is not performed (No in step S4), the ghost removal unit 60 determines whether the current I_{C}′ and the history I_{H} have the same data format (step S9).

In a case where the current and the history have the same data format (step S9: Yes), the ghost removal unit 60 replaces the values in the occlusion region of the corrected history I_{H}^{MC} with the corresponding pixel values in the current I_{C}′ (step S10). Subsequently, the processing proceeds to step S6. In a case where the current and the history have different data formats (step S9: No), the ghost removal unit 60 replaces the values of the occlusion region of the corrected history I_{H}^{MC} with the approximate feature amount I_{Ha} acquired from the current (Step S10). Subsequently, the processing proceeds to step S6.

### 3-4. Effects

The motion compensation unit 40 generates corrected history I_{H}^{MC} by performing the motion compensation on the intermediate feature amount I_{Hi} in the past frame inferred by the DNN 30, According to this configuration, the inference accuracy of the DNN 30 is increased compared to the inference accuracy achieved in a case where image data is input.

The ghost removal unit 60 performs, as the ghost removal processing, the processing of replacing the data of the occlusion region with the data of the approximate feature amount I_{Ha}. This configuration increases the degree of the similarity between the intermediate feature amount I_{Hi} in the current I_{C}′ and the corrected history I_{H}^{MC}. Accordingly, the consecutiveness of the video between frames is enhanced.

The approximate feature amount estimation unit 80 calculates, as the approximate feature amount I_{Ha}, an intermediate feature amount obtained by applying the current I_{C}′ to the optimized conversion model CV. This configuration can maximize the degree of similarity between the intermediate feature amount I_{Hi} in the current I_{C}′ and the corrected history I_{H}^{MC}.

### 4. Hardware Configuration Example

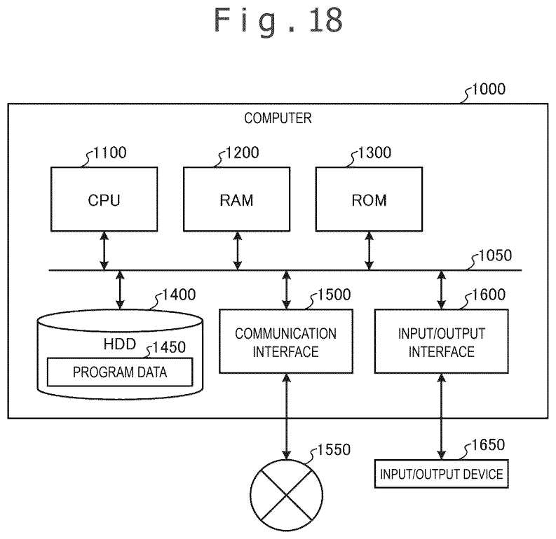

FIG. 18 is a diagram illustrating an example of a hardware configuration of the information processing apparatus 1, 2.

The information processing of the information processing apparatus is realized by, for example, a computer 1000. The computer 1000 includes a central processing unit (CPU) 1100, a random access memory (RAM) 1200, a read only memory (ROM) 1300, a hard disk drive (HDD) 1400, a communication interface 1500, and an input/output interface 1600. The units of the computer 1000 are connected together via a bus 1050.

The CPU 1100 operates based on a program (program data 1450) stored in the ROM 1300 or the HDD 1400, and controls each unit. For example, the CPU 1100 expands the program stored in the ROM 1300 or the HDD 1400 to the RAM 1200 and executes processing corresponding to various programs.

The ROM 1300 stores a boot program such as a basic input output system (BIOS) executed by the CPU 1100 at the time of activation of the computer 1000, a program depending on hardware of the computer 1000, and the like.

The HDD 1400 is a non-transitory computer-readable recording medium in which a program executed by the CPU 1100 and data used by the program are non-transitorily recorded. For example, the HDD 1400 is a recording medium in which an information processing program of the embodiment is recorded as an example of the program data 1450.

The communication interface 1500 is an interface for connecting the computer 1000 to an external network 1550 (for example, the Internet). For example, the CPU 1100 receives data from another piece of equipment via the communication interface 1500 or transmits data generated by the CPU 1100 to the another piece of equipment via the communication interface 1500.

The input/output interface 1600 is an interface for Connecting the input/output device 1650 and the computer 1000. For example, the CPU 1100 receives data from input devices such as a keyboard and a mouse via the input/output interface 1600. The CPU 1100 also sends data to output devices such as a display, speakers, and a printer via the input/output interface 1600. The input/output interface 1600 may function as a media interface that reads a program or the like recorded in a predetermined recording medium (media). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing apparatus of the embodiment, the CPU 1100 of the computer 1000 executes an information processing program loaded on the RAM 1200 to realize the functions of the above-described units. Additionally, the HDD 1400 stores the information processing program, various models, and various types of data of the present disclosure, Note that the CPU 1100 reads the program data 1450 from the HDD 1400 and executes the program, but in another example, the CPU 1100 may acquire these programs from another device via the external network 1550.

### Appendix

Note that the present technology may also take the following configurations.
(1)

An information processing apparatus including:
a motion compensation unit configured to generate corrected history by performing motion compensation on an inference result for a past frame;
an occlusion region detection unit configured to detect an occlusion region in the corrected history in which a ghost has a possibility of occurring, based on a motion vector indicating a motion of a subject between frames;
a ghost removal unit configured to perform ghost removal processing on the occlusion region; and
a DNN configured to infer a current frame, based on the corrected history on which the ghost removal processing has been performed and current that is an image of the current frame to be processed.
(2)

The information processing apparatus according to claim 1, wherein
the motion compensation unit generates the corrected history by performing the motion compensation on an. inferred image of the past frame inferred by the DNN.
(3)

The information processing apparatus according to claim 2, wherein
the ghost removal unit performs, as the ghost removal processing, processing of replacing pixel values of pixels in the occlusion region with blank data.
(4)

The information processing apparatus according to claim 2, wherein
the ghost removal unit performs, as the ghost removal processing, processing of replacing pixel values of pixels in the occlusion region with pixel values in the current.
(5)

The information processing apparatus according to claim 1, wherein
the motion compensation unit generates the corrected history by performing the motion compensation on an intermediate feature amount in the past frame inferred by the DNN.
(6)

The information processing apparatus according to claim 5, further including
an approximate feature amount estimation unit configured to acquire, as an approximate feature amount, a feature amount corresponding to the corrected history from the current, wherein
the ghost removal unit performs, as the ghost removal processing, processing of replacing data of the occlusion region with data of the approximate feature amount.
(7)

The information processing apparatus according to claim 6, wherein
the approximate feature amount estimation unit optimizes a conversion model in such a manner that an intermediate feature amount obtained by applying the conversion model to the current approximates an intermediate feature amount obtained by inputting the current to the DNN, and
calculates, as the approximate feature amount, the intermediate feature amount obtained by applying the current to the optimized conversion model.
(8)

The information processing apparatus according to any one of claims 1 to 7, wherein
the occlusion region detection unit,
determines, based on the motion vector, whether predetermined conditions are satisfied, the predetermined conditions being that a magnitude of misalignment between a foreground and a background is larger than a threshold value indicating noise and a moving direction of the foreground is different from a moving direction of the background, and
determines that a region of the background overlapping the foreground is the occlusion region, if it is determined that the predetermined conditions are satisfied.
(9)

The information processing apparatus according to claim 8, wherein
the occlusion region detection unit identifies the foreground and the background, based on depth information.
(10)

An information processing method performed by a computer, the information processing method including:
generating corrected history by performing motion compensation on an inference result for a past frame;
detecting an occlusion region in the corrected history in which a ghost has a possibility of occurring, based on a motion vector indicating a motion of a subject between frames;
performing ghost removal processing on the occlusion region; and
inferring a current frame, based on the corrected history on which the ghost removal processing has been performed and current that is an image of the current frame to be processed.
(11)

A computer-readable non-transitory storage medium storing a program causing a computer to:
generate corrected history by performing motion compensation on an inference result for a past frame;
detect an occlusion region in the corrected history in which a ghost has a possibility of occurring, based on a motion vector indicating a motion of a subject between frames;
perform ghost removal processing on the occlusion region; and
infer a current frame, based on the corrected history on which the ghost removal processing has been performed and current that is an image of the current frame to be processed.

### Reference Signs List

1, 2 Information processing apparatus
30 DNN
40 Motion compensation unit
50 Occlusion region detection unit
60 Ghost removal unit
80 Approximate feature amount estimation unit
I_{C}, I_{C}′ Current
I_{Ha} Approximate feature amount
I_{Hi} Intermediate feature amount
I_{H}^{MC} Corrected history
MV, MV′ Motion vector

1. An information processing apparatus comprising:
a motion compensation unit configured to generate corrected history by performing motion compensation on an inference result for a past frame;
an occlusion region detection unit configured to detect an occlusion region in the corrected history in which a ghost has a possibility of occurring, based on a motion vector indicating a motion of a subject between frames;
a ghost removal unit configured to perform ghost removal processing on the occlusion region; and
a DNN configured to infer a current frame, based on the corrected history on which the ghost removal processing has been performed and current that is an image of the current frame to be processed.

2. The information processing apparatus according to claim 1, wherein
the motion compensation unit generates the corrected history by performing the motion compensation on an inferred image of the past frame inferred by the DNN.

3. The information processing apparatus according to claim 2, wherein
the ghost removal unit performs, as the ghost removal processing, processing of replacing pixel values of pixels in the occlusion region with blank data.

4. The information processing apparatus according to claim 2, wherein
the ghost removal unit performs, as the ghost removal processing, processing of replacing pixel values of pixels in the occlusion region with pixel values in the current.

5. The information processing apparatus according to claim 1, wherein
the motion compensation unit generates the corrected history by performing the motion compensation on an intermediate feature amount in the past frame inferred by the DNN.

6. The information processing apparatus according to claim 5, further comprising
an approximate feature amount estimation unit configured to acquire, as an approximate feature amount, a feature amount corresponding to the corrected history from the current, wherein
the ghost removal unit performs, as the ghost removal processing, processing of replacing data of the occlusion region with data of the approximate feature amount.

7. The information processing apparatus according to claim 6, wherein
the approximate feature amount estimation unit
optimizes a conversion model in such a manner that an intermediate feature amount obtained by applying the conversion model to the current approximates an intermediate feature amount obtained by inputting the current to the DNN, and
calculates, as the approximate feature amount, the intermediate feature amount obtained by applying the current to the optimized conversion model.

8. The information processing apparatus according to claim 1, wherein
the occlusion region detection unit
determines, based on the motion vector, whether predetermined conditions are satisfied, the predetermined conditions being that a magnitude of misalignment between a foreground and a background is larger than a threshold value indicating noise and a moving direction of the foreground is different from a moving direction of the background, and
determines that a region of the background overlapping the foreground is the occlusion region, if it is determined that the predetermined conditions are Satisfied.

9. The information processing apparatus according to claim 8, wherein
the occlusion region detection unit identifies the foreground and the background, based on depth information.

10. An information processing method performed by a computer, the information processing method comprising:
generating corrected history by performing motion compensation on an inference result for a past frame;
detecting an occlusion region in the corrected history in which a ghost has a possibility of occurring, based on a motion vector indicating a motion of a subject between frames;
performing ghost removal processing on the occlusion region; and
inferring a current frame, based on the corrected history on which the ghost removal processing has been performed and current that is an image of the current frame to be processed.

11. A computer-readable non-transitory storage medium storing a program causing a computer to perform:
generating corrected history by performing motion compensation on an inference result for a past frame;
detecting an occlusion region in the corrected history in which a ghost has a possibility of occurring, based on a motion vector indicating a motion of a subject between frames;
performing ghost removal processing on the occlusion region; and
inferring a current frame, based on the corrected history on which the ghost removal processing has been performed and current that is an image of the current frame to be processed.
